(19) United States
(12) Patent Application Publication
(10) Pub. No.: US 2008/0129695 A1
(43) Pub. Date: Jun. 5, 2008

(54) FOOT-OPERATED ELECTRONIC MOUSE

(76) Inventor: Tianhou Li, Walnut, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/566,088

(22) Filed: Dec. 1, 2006

(51) Int. Cl. G06F 3/033

(52) U.S. Cl. 345/163

(57) ABSTRACT

A foot-operated controller is disclosed for controlling a display device. The device is manipulated by a user's feet in order to send commands to a display device. The foot-operated controller can communicate with a display device either wirelessly or through a cable. The foot-operated controller may use buttons, joysticks, track balls, scroll rollers, infrared switches, or any other useful control mechanisms for sending commands to a display device.

### FIELD OF THE DISCLOSURE

The present disclosure relates to a device for providing user inputs to a computer or other display device by manipulation from a user's feet.

### BACKGROUND

Computers, display devices, and display screens have become increasingly important in today's society. They have become integral for many people in their daily work and entertainment. Typical computer systems include a hand-operated mouse, keyboard, and monitor. The mouse and keyboard provide user inputs for telling the computer what to do, while the monitor provides a user output, displaying information to a user. Other electronic devices and display devices also typically provide some kind of hand operated user input coupled with a user output.

Despite the growing importance and wider range of uses for electronic devices, there is still a need in many fields to adapt electronic devices for a particular use. For example, during music performances, most performers still need to turn over sheets of music score by hand. While practicing, a performer may need to stop in the middle of a musical piece in order to turn the page. For formal performance, many performers need others to turn over the pages of sheet music for them. In situations where a performer must perform in dark environments, a lamp or other light source must be provided in order to view the sheet music often causing a distraction from the rest of the performance.

A typical computer system will not be useful for musical performers who must use both hands to play their instrument because they do not have a free hand to move to the next screen display of music. In addition, disabled people, seniors, dentists, medical doctors, lab researchers, mechanics, cook, factory workers, video gamers or any other people with handicapped, occupied, stressful or dirty hands also need a system for entering data, typing, editing, surfing Internet, creating one-button access (e.g., shortcuts, etc.), reducing hand stress, improving productivity or controlling a display device, such as a computer, with something other than their hands.

### SUMMARY

These and other problems are solved by a foot-operated electronic device controller. A foot-operated electronic device controller is provided to allow an operator to control computer functionality as an alternative or in addition to using their hands. For musical performers, the foot-operated controller has many advantages. Compared with paper display, electronic display monitors or screens provide their own light source, eliminating the need for separate light sources which may cause additional distractions from other parts of a performance. Additionally, computers and other electronic devices do a better job of storing, organizing and tracking images, text, or score than paper media. By using computers or other electronic devices with monitors or display screens in conjunction with a foot-operated controller, the need to turn a page by hand can be eliminated.

Other types of users will also benefit from a foot-operated electronic device controller. For instance, disabled people, senior citizens, dentists, medical doctors, mechanics, video gamers or other people with busy, stressful, dirty or handicapped hands will find the foot-operated device useful because it provides a way to enter data, type, edit file, surf Internet, create one-button access (e.g., shortcuts, etc.), reduce hand stress, improve productivity or control a display device.

In one embodiment, the foot-operated electronic device controller includes a foot-activating control pad, a signal transmitting mechanism, a control mechanism, and signal converting mechanism. The signal transmitting mechanism can exchange signals with computers, monitors and other displaying screens. The control mechanism generates signal through control movement. The signal converting mechanism can change movement signal into identifiable/recognizable signals for computer, monitor or other display screen.

In one embodiment, the signal transmitting module includes a signal transferring data connector. The data connector has one end provided to an electronic device, such as, for example, a computer, a monitor or other display screen, and the other end provided to the foot control pad. In one embodiment, the signal transmitting module communicates with the electronic device wirelessly, such as through an Infrared, wireless wave, blue-tooth transmission or any other wireless transmission. In this configuration, a wireless transceiver is connected to the signal converting mechanism. A wireless transceiver is also provided to a data port of the electronic device.

The control mechanism can be a button, a stick, a joystick, a lever, a plate, a touch-screen style control, a light-electronic sensor, or any other control mechanism. For example, a standing performer may prefer to use a light-electronic sensor control mechanism.

In one embodiment, the control mechanism has two or more buttons on top of the control pad. The buttons are connected to the signal converting mechanism. In one embodiment, a first button generates a forward page turn signal. In one embodiment, a second button generates a backward page turn signal. The control mechanism can be a stick, such as a joystick, or lever, or plate set on top of the pad. Moving the control mechanism left/right or forward/backward generates appropriate signals that are sent to the electronic device. The control mechanism can be two pairs of interactive LED light generators and optical sensors. Generators and sensors are generally set apart with a certain distance. The light sensor is connected with a signal converting mechanism. When the light is blocked, such as by placing a foot in between the light generator and light sensor, the optical sensor generates a forward or backward page turning signal.

In one embodiment, the signal converting mechanism is a device for changing the control movement into a wireless signal. The signal converting mechanism converts a physical movement into an infrared or blue-tooth signal.

The display device and display screen can be a monitor, projector, a television, a personal digital assistant (PDA), or other display device.

The display device can include a processor, data input port, data output port, and data storage. In one embodiment, data is received at the data input port. The processor processes the data and can send the data to the output port, data storage, a display device, or any combination thereof.

In one embodiment, the foot-operated electronic device controller enables a user to control an electronic device such as a computer. In one embodiment, the foot-operated electronic device controller enables a user to control an electronic device such as a television or monitor for displaying text or images, such as, for example, music score. A user can use the foot-operated electronic device controller in parallel with a hand-operated controller or independent of a hand-operated controller. In operation, the foot-operated electronic device controller is hands free and provides convenience for music performers during both practice and performance. In addition to music performers, the foot-operated electronic device controller is also useful for disabled people and/or people with carpal tunnel syndrome to enter data, type, edit, file, surf the Internet, create one-button access, reduce hand stress, improve productivity, control to control electronic devices, etc. Data transmission using cabled or wireless method allows the controller to be adapted for different situations. For example, during live music performance, transmission with cables can avoid the interference between electronic signals, which may affect the result of application or interfere with the signals of other electronic systems. For home practice, a wireless version can be very convenient.

### BRIEF DESCRIPTION OF THE DRAWINGS

FIG. 1A is a top view of an embodiment of a foot-operated controller.

FIG. 1B is a side view of the embodiment of FIG. 1A.

FIG. 1C is a bottom view of the embodiment of FIG. 1A.

FIG. 2A shows the components of a foot-operated controller.

FIG. 2B shows the components of a wireless foot-operated controller.

FIG. 3A is a side view of a button control mechanism.

FIG. 3B is a top view of a button control mechanism.

FIG. 3C is a side view of a joystick control mechanism.

FIG. 3D is a top view of a joystick control mechanism.

FIG. 3E is a side view of a light-electronic control mechanism.

FIG. 3F is a top view of a light-electronic control mechanism.

FIG. 4 is a two piece foot-operated controller.

FIG. 5A is one embodiment of a foot-operated controller having two buttons, a scroll roller and a track ball.

FIG. 5B is one embodiment of a foot-operated controller with speaker and volume control.

FIG. 6A is one embodiment of a foot-operated controller with three prong layout.

FIG. 6B is one embodiment of a foot-operated controller with three prong layout.

FIG. 6C is one embodiment of a foot-operated controller with three prong layout.

FIG. 7A is one embodiment of a foot-operated controller with four prong layout.

FIG. 7B is one embodiment of a foot-operated controller with four prong layout.

FIG. 8 is one embodiment of a foot-operated controller with four buttons.

FIG. 9 is one embodiment of a foot-operated controller with two buttons, a scroll roller and a track ball.

FIG. 10A is one embodiment of a foot-operated controller with a five prong layout.

FIG. 10B is one embodiment of a foot-operated controller with a circular layout.

FIG. 11 is one embodiment of a foot-operated controller with an adjustable pressure knob.

FIG. 12 is a top view of one embodiment of a multi-level foot-operated controller.

FIG. 13 is a side view of one embodiment of a multi-level foot-operated controller.

FIG. 14 illustrates operation of controls in an upper-level of a multi-level foot-operated controller.

FIG. 15 illustrates operation of controls in a lower-level of a multi-level foot-operated controller.

FIG. 16 is a side view of one embodiment of a multi-level foot-operated controller with ergonomic sloping.

FIG. 17 shows a foot-operated mouse with attachment straps.

FIG. 18 shows use of the foot-operated mouse of FIG. 17.

FIG. 19 shows an open-style foot-operated mouse.

FIG. 20 shows a side view of the open-style foot-operated mouse of FIG. 19.

FIG. 21 is a top view of an open-style foot-operated mouse with a toe guard.

FIG. 22 is a side view of the foot-operated mouse shown in FIG. 21.

FIG. 23 is a front view of the foot-operated mouse shown in FIG. 21.

FIG. 24 shows an example of a graphical user interface for assigning functions to buttons on a foot-operated controller.

### DETAILED DESCRIPTION

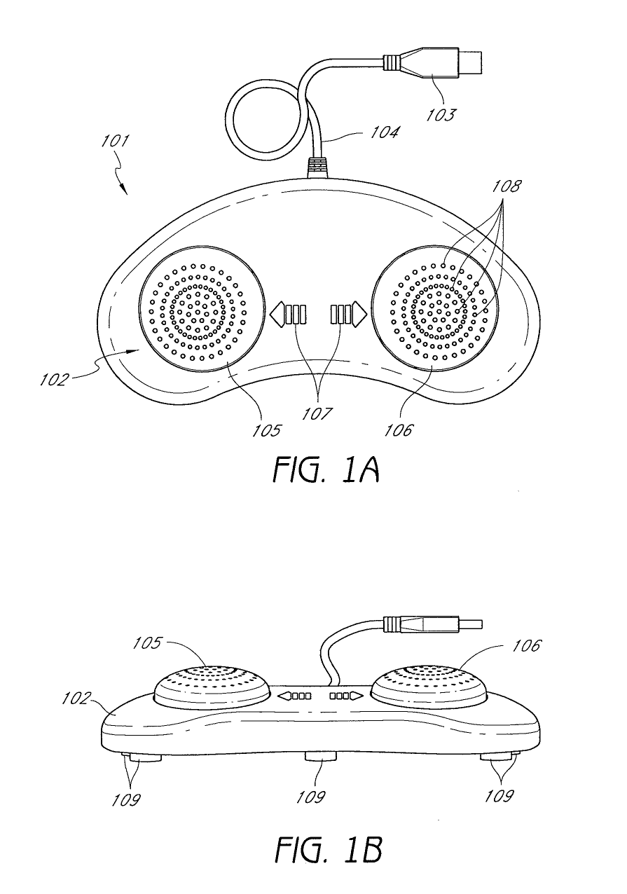

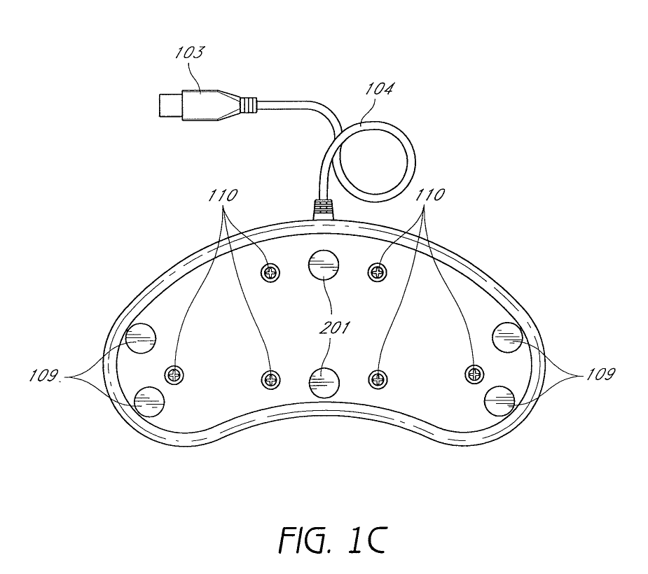

FIG. 1A illustrates a top view of an embodiment of a foot-operated controller 101. As can be seen, the housing 102 of the foot-operated controller 101. Housing 102 is generally arc shaped with rounded curves. In one embodiment, housing 102 is generally kidney bean shaped. Buttons 105 and 106 are provided on the top of housing 102. Buttons 105 and 106 are shown as circular in shape but may be of any shape or design. Buttons 105 and 106 are provided with bumps 108 which help provide traction for operating foot-operated controller 101. Markings 107 are also optionally provided to indicate to a user the operational functionality associated with each button 105 and 106. A cable 104 connects the foot-operated controller 101 to a display device, such as a computer, via plug 103. The plug 103 may be any type of connector, including a Universal Serial Bus connector. In one embodiment, foot-operated controller 101 communicates with a display device through wireless transmission without the use of a cable, such as cable 104. In one embodiment, the buttons 105 and 106 are separated to allow room for foot operation. For example, in one embodiment, the buttons 105 and 106 are 2 inches apart center to center. In one embodiment, the buttons 105 and 106 are 1 inch apart center to center. In one embodiment, the buttons 105 and 106 are 3 inches apart center to center. In one embodiment, the buttons 105 and 106 are at least ½ inch apart from edge to edge. In one embodiment, the buttons 105 and 106 are at least 2 inches apart edge to edge. In one embodiment, lighting is provided to the buttons 105, 106 to allow the user to see them more easily in the dark.

FIG. 1B illustrates a side view of the embodiment of FIG. 1A. As can be seen in FIG. 1B, foot-operated controller 101 has a selectively smooth curved upper surface. In one embodiment, housing 102 is ncursorer at a front edge, and wider at a back edge. In addition, buttons 105 and 106 are raised above the surface of the covering 102. In operation, a user will push down on buttons 105 and 106 causing the buttons 105 and 106 to shift downward relative to the housing 102. The downward shift activates a signal that is sent to the display device. Also shown in FIG. 1B are traction pads 109 on the bottom of the housing 102. The traction pads 109 provide traction to the housing 102 to prevent the housing 102 from moving during operation.

FIG. 1C illustrates a bottom view of the embodiment of FIG. 1A. As can be seen in FIG. 1C, traction pads 109 are advantageously dispersed around the outer circumference of housing 102 to provide traction and support. Screws 110 can also be seen which hold the housing 102 together.

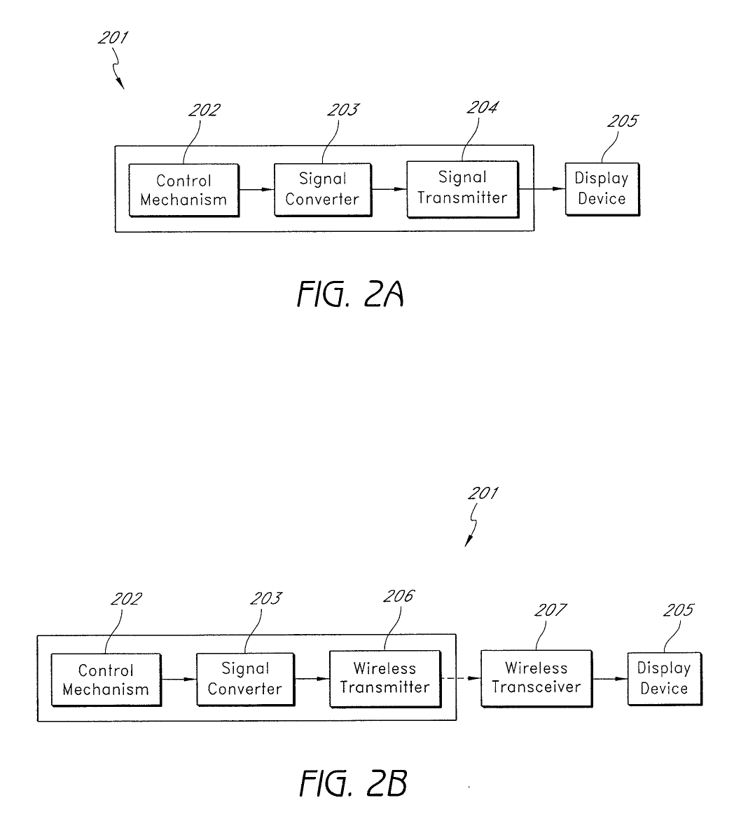

FIG. 2A is a functional blade diagram of a hard wired foot-operated controller 201. The foot-operated controller 201 has functional components including a control mechanism 202, a signal converter 203, and a signal transmitter 204. The foot-operated controller 201 then communicates with a display device 205, such as a computer, television, PDA, or other electronic device, through signal transmitter 204 which is connectable with the display device 205. The control mechanism 202 generates signal through control movement. The control mechanism 202 can be any commonly used method of movement, such as a conventional roller mouse, optical mouse, a switch, plate, sensor, control stick, such as a joystick commonly used with video games, push-button controls, track ball, scroll roller, or other various commonly used signal generating methods or the like for a user to activate in order to send a signal to the display device 205.

Once the control mechanism 202 is activated by a user, the control mechanism 202 sends a mechanical or electrical signal to the signal converter 203. The signal converter 203 converts the signal from the control mechanism 202 to a signal communicable with the display device 205. Normally, this signal is an electronic signal, but it can be other types of signals as well.

The signal converter 203 then sends the signal via signal transmitter 204 to display device 205. The transmitted signal can be recognized by a computer and other display devices. In one embodiment, before the signal's transmission, a special coding section can be used. Then, decoding software can be installed in the computer and other devices. This way a special signal transmission can be realized to improve the anti-interference ability of signal. In one embodiment, to define the functions or change the commands of each button based on user's need, software is provided to computer or processor that can convert signals generated by buttons into different functions or commands selected by the user.

In one embodiment, the signal transmitter 204 is a cable. The cable can be a USB data cable, audio frequency cable, or video frequency cable, IEEE 1394 firewire, or any other cable for communicating with a computer, television, PDA, or other display device. One end of the cable is connected with a computer or other display device 205, while the other end is connected with foot-operated controller 201. Preferably, the cable's display device end connector fits commonly built sockets of existing computer and other display devices, such as USB socket, multi-pin socket, audio frequency socket, video frequency socket, microphone socket, or the like.

FIG. 2B illustrates a schematic functional diagram of a wireless foot-operated controller 201. The wireless controller functions similarly to the wired foot-operated controller 201 of FIG. 2A. However, instead of sending a signal over the cable 204 to display device 205, the foot-operated controller sends a wireless signal. A user activates a control mechanism 202 which sends a signal to signal converter 203. Signal converter 203 then communicates the signal to a wireless transmitter 206 which converts the signal to a wireless signal and broadcasts the wireless signal. The wireless signal is then received by wireless transceiver 207, which converts the wireless signal to an electrical signal communicable with the display device 205. Wireless transceiver 207 then sends the signal to the display device 205. The wireless transceiver may send any advantageous wireless signal including infrared, Bluetooth, cellular, or the like.

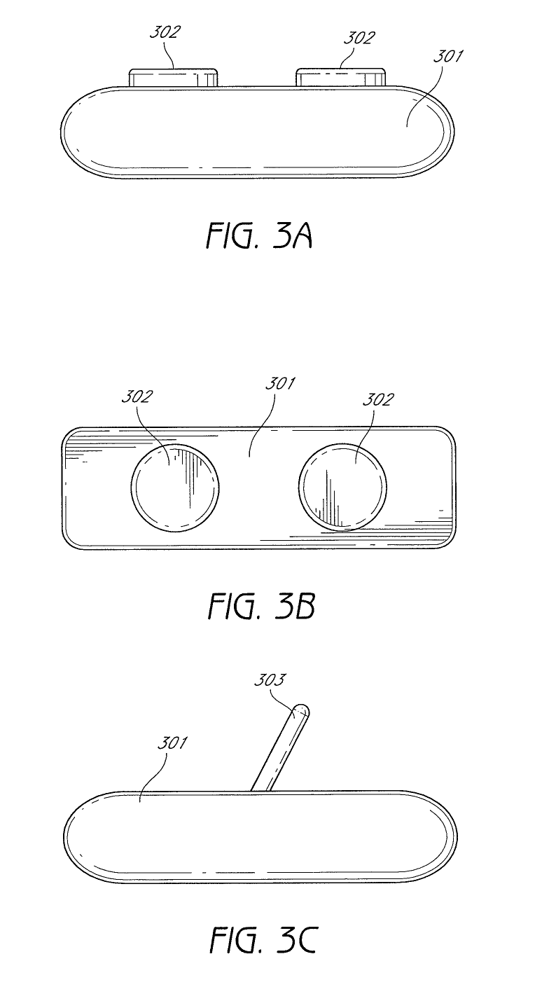

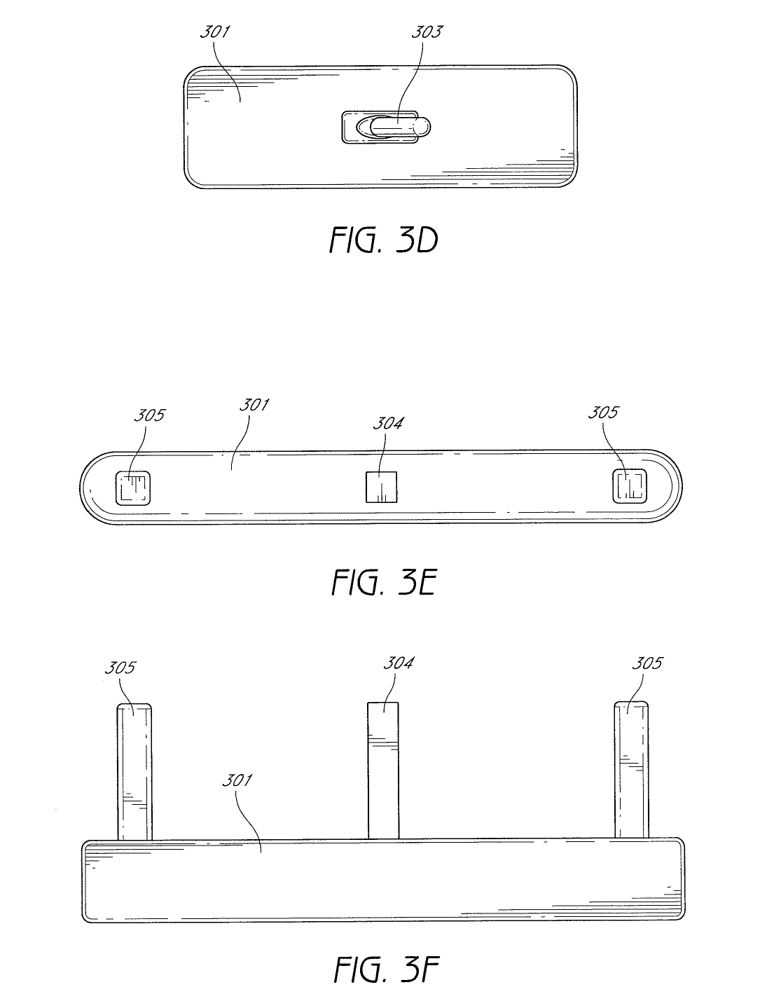

FIGS. 3A and 3B illustrate a side and top view of one embodiment of a control mechanism which has two buttons 302 on top of a case 301. The buttons 302 are connected with signal transmitter 204 from the lower parts of the buttons 302. One of the buttons 302 is used to generate a signal of forward page turning, while the other button 302 is used to generate a signal of backward page turning. The buttons 302 are relatively larger for the convenience of foot/feet stepping.

FIGS. 3C and 3D is a side and top view of another embodiment of a foot-operated controller with a joystick 303. The lower part of the joystick 303 is set on top of a case 301. The lower part of the joystick 303 is connected with signal converting mechanism 203. In operation, the joystick can be moved forward or backward, or from side to side in order to generate an appropriate command signal to be sent to the display device 205.

FIGS. 3E and 3F are a side and top views of yet another embodiment of a foot-operated controller with optical sensors 305. The control mechanism has two sets of interactive LED light generators 304 and optical sensors 305. The light generators 304 and the sensors 305 are separated so as to allow a space in between the light generator 304 and optical sensors 305. The optical sensors 305 are provided to the signal converting mechanism 203. The light generators 304 generate an infrared beam of light that is sensed by the optical sensors 305. When the beam of light is blocked, optical sensors 305 generates a control signal and communicates that control signal to signal converting mechanism 203. A foot, or other object, is inserted between the light generators 304 and optical sensors 305 in order to block the infrared beam

In one embodiment, the control mechanism is a touch screen display. By touching the different parts of a screen, a signal can be generated for communication with the display device 205.

The foot-operated controller is designed to be used in conjunction with a display device, such as display device 205. In one embodiment, the display device includes a processor, a data input port, a data output port, a display screen, and data storage (memory). For example, the display device may be a computer, a personal digital assistant (PDA), a cell phone, or any other electronic device capable of processing data. In one embodiment, the display device is a television. In one embodiment, the display device is a monitor. In this embodiment, the foot-operated controller connects directly to a monitor for display purposes.

In one embodiment, the foot-operated controller communicates with a network. The network then communicates the control signals generated by the controller to multiple display devices. This embodiment may be particularly useful for a group of performers such as an orchestra or band, or a group of participants, such as in a classroom setting. In this embodiment, the foot-operated controller is operated by one person so that one person can control multiple display screens simultaneously.

In one embodiment, software is included to make the foot-operated controller compatible with music composing/displaying software. In one embodiment, a device driver is provided to make the foot-operated controller compatible with display devices, such as, for example, a computer or PDA. In one embodiment, software can help the user to define the functions or commands of each button. The software can be used to program the foot-operated controller to help the user to types, enter data, surf the Internet, create one-button access shortcuts, improve productivity or reduce hand stress.

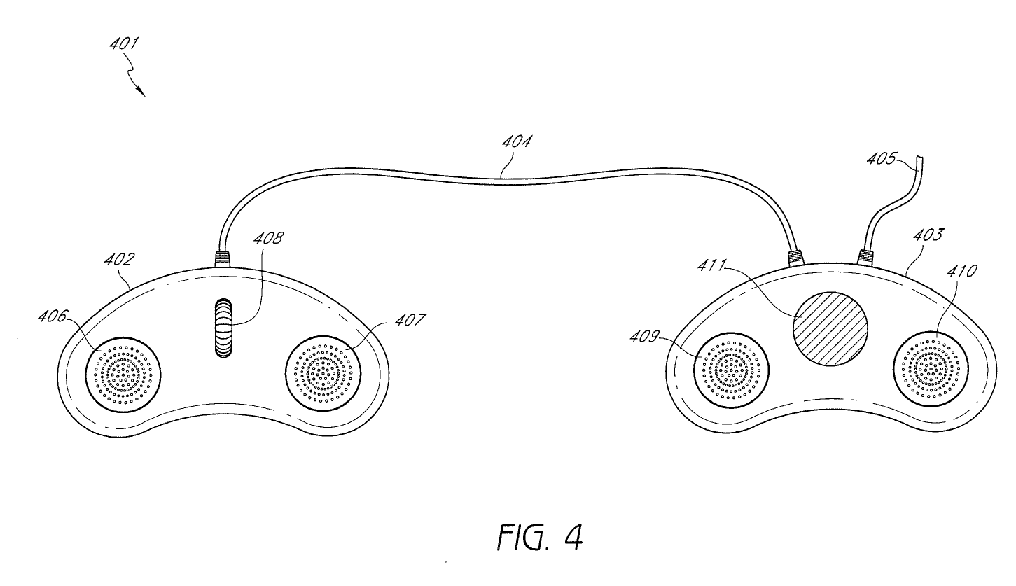

FIG. 4 illustrates one embodiment of a two-piece foot-operated controller 401. A two-piece foot-operated controller, such as the one shown in FIG. 4, provides easier and faster control with both feet. A user can switch the positions of the two pieces of the controller depending on the user's preference. A two piece controller also allows for added control mechanisms and feedback indicators. The two pieces of the controller can be connected by a cable, or they can communicate wirelessly. In one embodiment, both controllers communicate directly with the display device. In one embodiment, one piece is the master device and the other is the slave, such that one piece communicates signals to the other piece which then coordinates communication with the display device. In one embodiment, the two sections of the mouse can be moved closer or spaced farther apart in order to adjust the space between the buttons depending on the user's preferences.

Referring again to FIG. 4, the two piece foot-operated controller has a first controller 402 and a second controller 403. The first controller 402 communicates signals to the second controller 403 via a communication link 404. The second controller 403 then communicates signals generated from both the first and second controllers to the display device via communication link 405. The first controller 402 has a left click button 406 and a right click button 407. The first controller 402 also has a scroll roller 408. The second controller 403 has a page up button 409 and a page down button 410 as well as an cursor control 411. Cursor control 411 can be a track ball, pressure pad, joystick, or any other control mechanism that allows for multi-direction control. It will be understood by one of ordinary skill in the art that the various buttons and controls can be assigned different functionality based on the needs of the user.

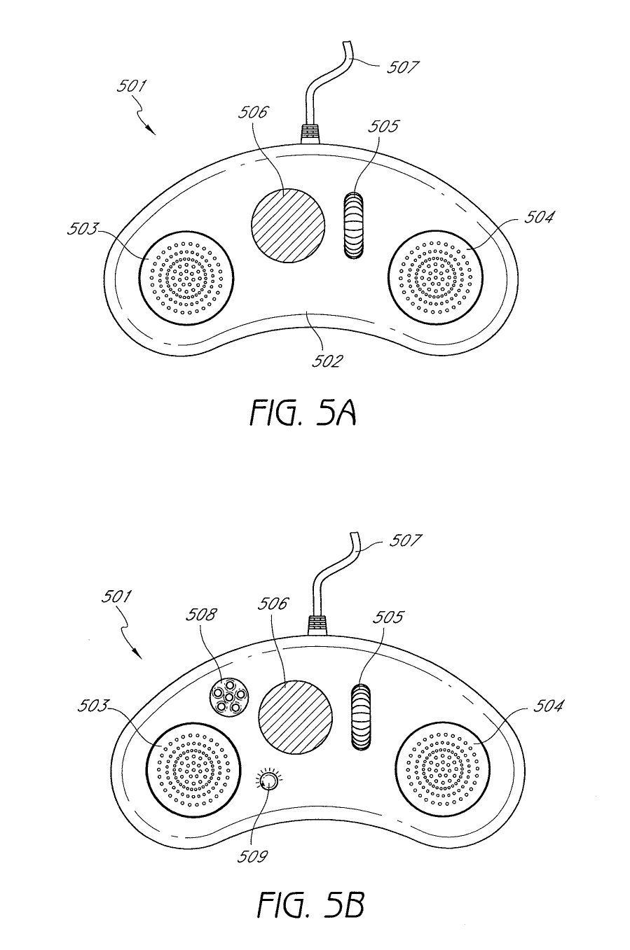

FIG. 5A illustrates one embodiment of a foot-operated controller 501. The foot-operated controller 501 includes a housing 502, a left button 503, a right button 504, a scroll roller 505, an cursor control ball 506, and a communication link 507. The two buttons, 503 and 504 are placed near the outer edges on the top of the housing 502. The cursor control ball 506 is placed in the middle on the top of the housing 502. The scroll roller is placed in between the right button 504 and the cursor control ball 506. It will be understood by one of skill in the art that the control mechanisms can be positioned anywhere on the housing as is advantageous to one of skill in the art. For instance, the left and right buttons 503 and 504 can be placed adjacent to each other and the cursor control ball placed on the opposite side of the housing 502. The scroll roller 505 may also be placed on the left side of the cursor control ball 506, or in any other advantageous configuration.

FIG. 5B illustrates yet another embodiment of a foot-operated control mechanism 501. The embodiment of 5B is very similar to the embodiment of 5A, however, 5B has the added features of a speaker 508 and a volume control 509. The volume control 509 can be a knob, a switch, a button, a scroll roller, a joystick, a track ball, a pressure pad, or any other mechanical or electrical sensor.

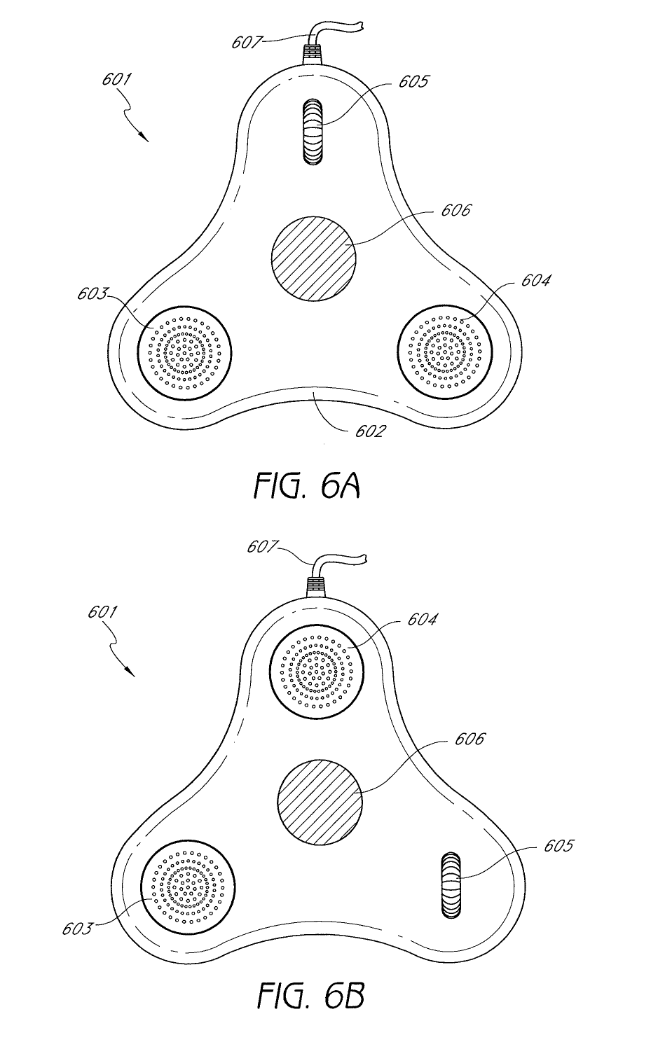

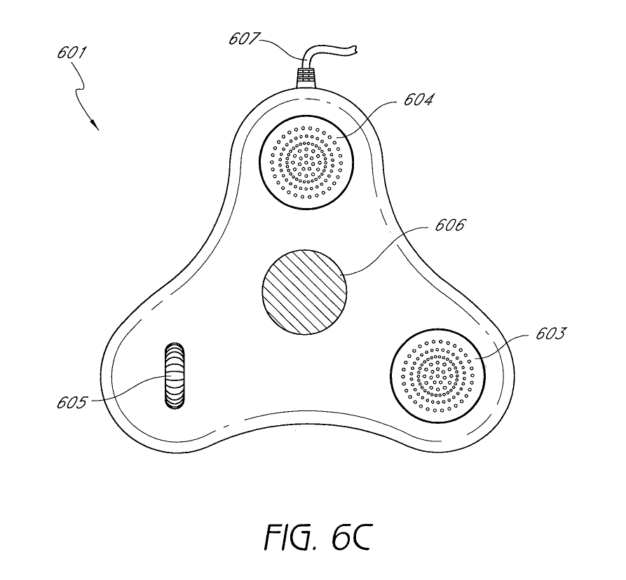

FIG. 6A illustrates one embodiment of a foot-operated controller 601. The foot-operated controller 601 has a housing 602 that has three prongs for control mechanism placement. A left click button 603 is placed on the lower left prong of housing 602. A right click button 604 is placed on the lower right prong of housing 602. A scroll roller 605 is placed on the top center prong of housing 602. An cursor control 606 is placed in the center of the housing 602. FIGS. 6B and 6C illustrate alternative embodiments of FIG. 6A in which the various control parts have been rearranged. In FIG. 6B, the scroll roller 605 is placed on the lower right prong of housing 602, while the right click button 604 is on the upper central prong of housing 602. In FIG. 6C, the scroll roller 605 is placed on the lower left prong of housing 602, while the right click button 604 is on the upper central prong, and the left click button 603 is on the lower right prong of housing 602.

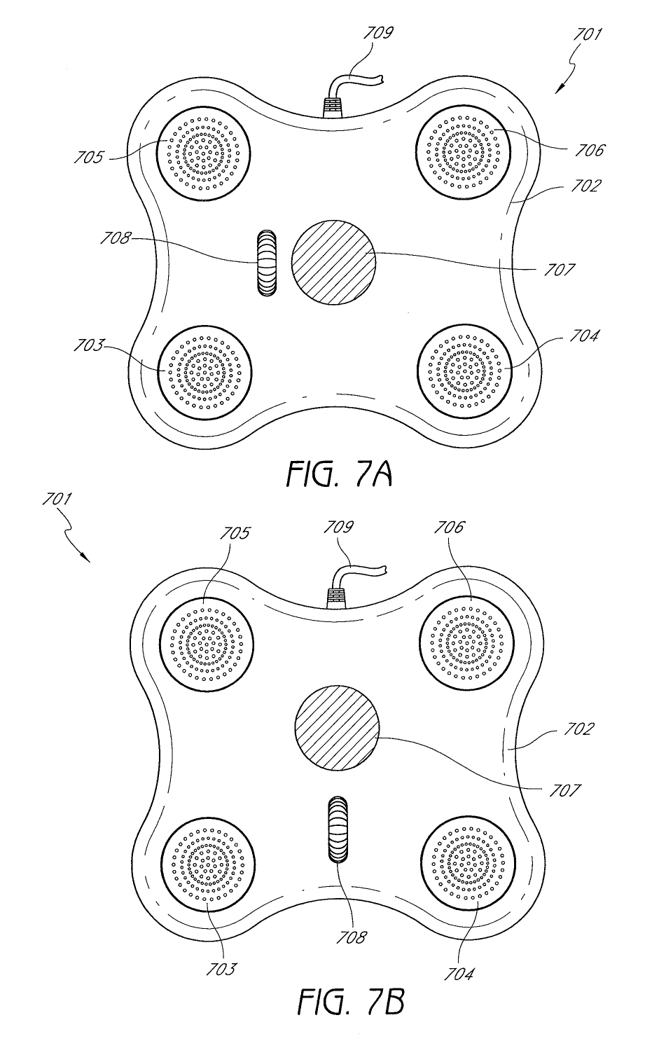

FIG. 7 illustrates one embodiment of a foot-operated controller 701 with a four prong housing 702. A left click button 703 is placed in the lower left prong of housing 702. A right click button 704 is placed in the lower right prong of housing 702. A page up button 705 is placed in the upper left prong of housing 702. A page down button 706 is placed in the upper right prong of housing 702. An cursor control 707 is placed in the middle of housing 702. A scroll roller 708 is placed on the left side of the cursor control 707. FIG. 7B illustrates an alternative embodiment to FIG. 7A in which the scroll roller is placed below the cursor control 707 on housing 702.

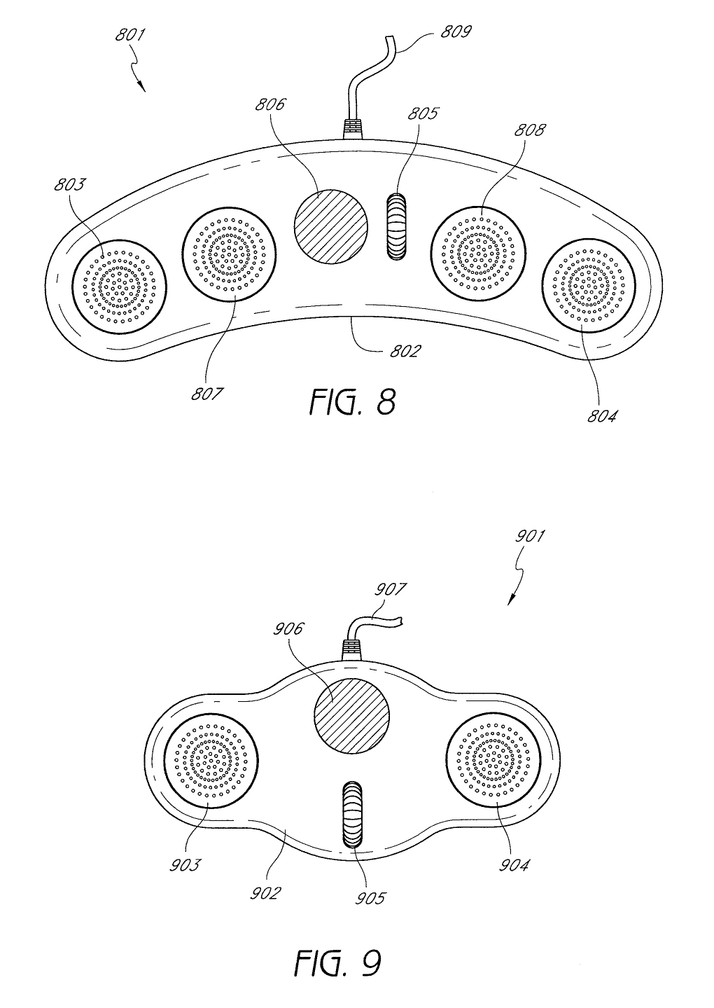

FIG. 8 illustrates another embodiment of a foot-operated controller 801 with a wide, generally parabolic housing 802. The housing 802 is wide in order to accommodate more control mechanisms. The housing 802 has six separate control mechanisms spread across the width of the housing 802. Starting from left to right, the housing 802 includes a left click button 803, a page up button 807, a cursor control 806, a scroll roller 805, a page down button 808, and a right click button 804.

FIG. 9 illustrates another embodiment of a foot-operated controller 901. The foot-operated controller 901 has a housing 902 on which a left click button 903, a right click button 904, a scroll roller 905, and a cursor control 906 are placed.

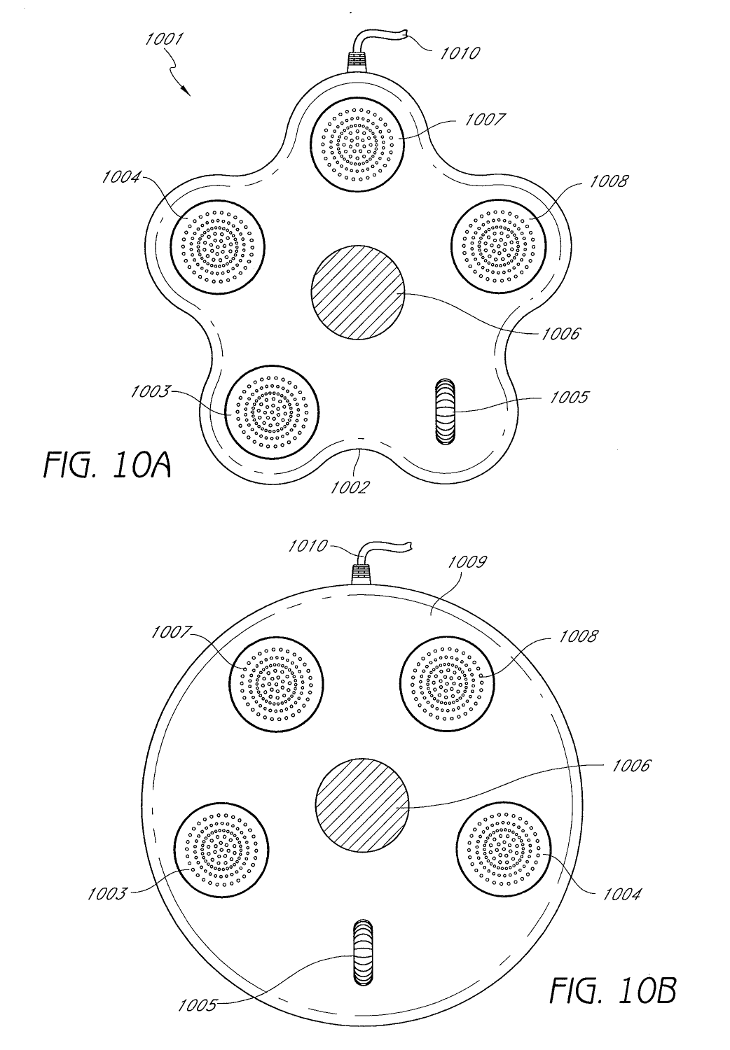

FIGS. 10A and 10B illustrate more embodiments of a foot-operated controller 1001 in which an cursor control 1006 is placed in the middle of a housing 1002 and five control mechanisms are spread around the perimeter of the housing 1002. FIG. 10A illustrates an embodiment in which the five perimeter control mechanisms are placed on a separate prong of the housing 1002. FIG. 10B illustrates an embodiment in which the housing 1002 is generally circular and the five control mechanisms are spaced along the outside perimeter of the housing.

In one embodiment, a user must press the buttons with a certain amount of force. For example, a typical hand-operated mouse may require very little force to be applied before a click signal is generated. However, the foot-operated controller requires relatively more force to be applied before generating a click signal. In one embodiment, 1/9th of a pound or more of force must be exerted before a single click signal is generated. In one embodiment, one pound or more of force must be generated before a single click signal is generated. The foot-operated controller can generate a click signal with anywhere from near zero pounds to up to a designed maximum. In one embodiment, a certain amount of pressure is exerted to create a single click, and a greater amount of pressure is exerted to create a double click. In one embodiment, the amount of pressure needed to generate a click signal is adjustable.

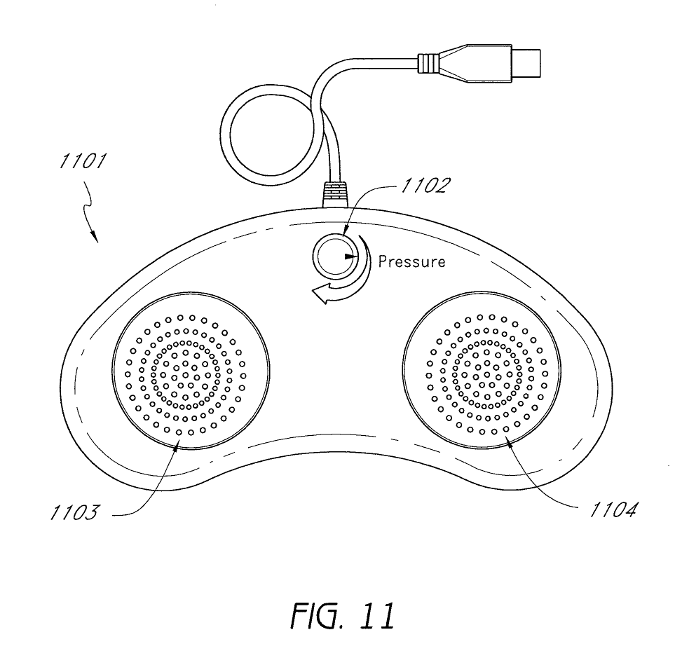

FIG. 11 illustrates one embodiment of a foot-operated controller 1101 with adjustable pressure knob 1102. Adjustable pressure knob 1102 is used to adjust the amount of pressure that must be applied to buttons 1103 and 1104 before a click signal is generated. In one embodiment, the pressure knob 1102 adjusts the amount of pressure needed to create both a single and double click. In one embodiment, multiple pressure adjusting knobs are provided to individually adjust the pressure for single and double click generation and/or for each button.

In one embodiment, the pressure that must be applied to buttons 1103 and 1104 before a click signal is generated is electronically adjustable. In one embodiment, an up-down switch is located on the foot-operated device controller for adjusting the pressure settings. In one embodiment, an LCD display, or other type of display, is located on the foot-operated device controller for displaying the pressure settings. In one embodiment, the pressure settings are manipulated on a computer. For example, in one embodiment, a software interface is provided which allows and a user to control the pressure settings. Of course, it is to be understood by a person of ordinary skill in the art that any method of electronically adjusting the pressure settings may be used.

In one embodiment, a pressure transducer is included in a foot-operated electronic device controller. The pressure transducer senses the amount of pressure applied to one or both of buttons 1103 and 1104. A user can designate the amount of pressure required for a single click signal, as well as the amount of pressure required for a double click.

In one embodiment, a scroll button is provided to allow a user to scroll up or down depending on the amount of pressure applied to the button. In one embodiment, a pressure transducer is provided to measure applied pressure. In one embodiment, a linear sensor is included to measure an amount of movement in the button. In one embodiment, the amount of pressure applied is measured based on how far down the button is being pressed. In operation, as the user applies pressure to the scroll button, the page view begins to scroll. The more pressure that is applied, the faster the view scrolls. The scroll action can be adjusted to scroll up or down or from side to side. Any other advantageous scroll action can also be accomplished with the scroll button.

In one embodiment, an indicator light is connectable to a display device. The indicator light communicates with the foot operated controller. In one embodiment, the indicator light lights up when the foot operated controller is powered on. In one embodiment, the indicator light lights up when the control mechanism is activated.

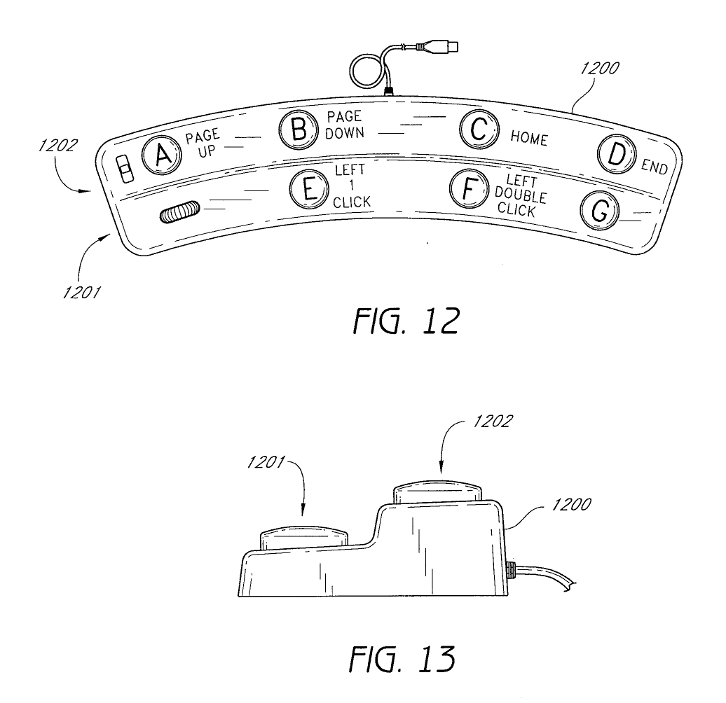

FIG. 12 is a top view of one embodiment of a multi-level foot-operated controller 1200. When foot operated controller, such as those shown in FIGS. 6A-7B, includes more than one row of input controls (e.g., buttons, scroll wheels, trackballs, etc.), access to the various controls may be somewhat impaired. The multi-level foot-operated controller 1200 provides multiple-levels for the various control devices, thereby making it easier to operate the devices using the foot. The controller 1200 shown in FIG. 12 includes input controls on a first level 1201 and input controls on a second level 1202. FIG. 12 shows the first level 1201 having a scroll wheel and three buttons and the second level 1202 having four buttons.

One of ordinary skill in the art will understand that FIG. 12 shows two levels by way of example and not by way of limitation. The multi-level controller can be configured to place controls on more than two levels, and the multi-level controller can be configured with various combinations of buttons, scroll wheels, trackballs, etc., on various levels as desired. One of ordinary skill in the art will further recognize that the multi-level controller 1200 can be configured with features and capabilities described in connection with the foot-operated controllers in FIGS. 1-11, such as, for example, wireless interface, USB interface, adjustable pressure, indicator lights, etc.

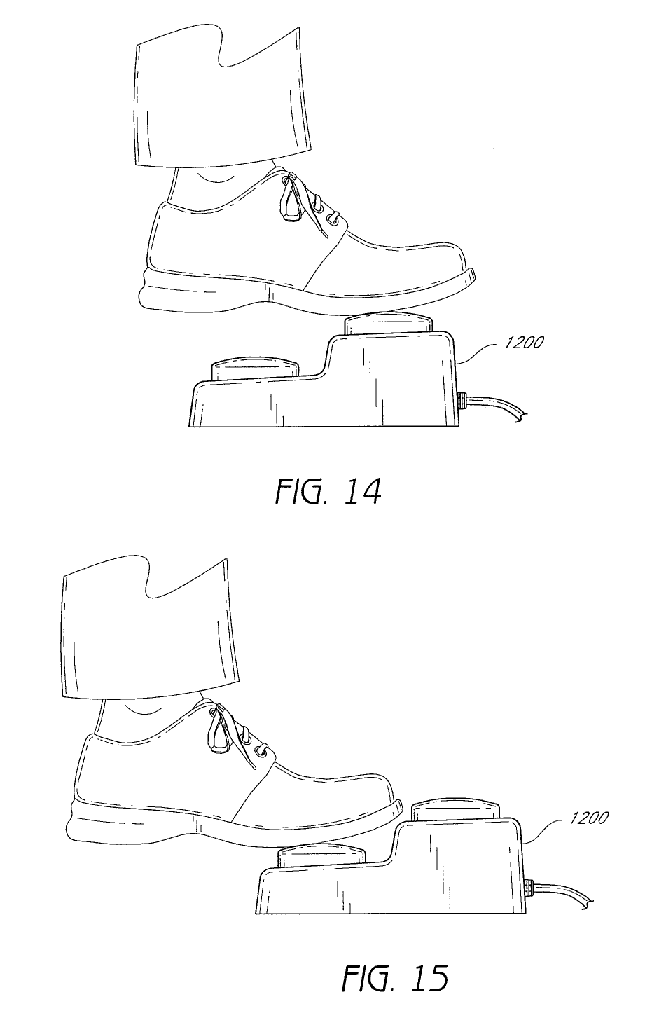

FIG. 13 is a side view of one embodiment of the multi-level foot-operated controller 1200 wherein the various control devices are oriented relatively horizontally. FIG. 14 shows foot operation of controls on the upper level 1202. FIG. 15 shows operation of the controls on the lower level 1201.

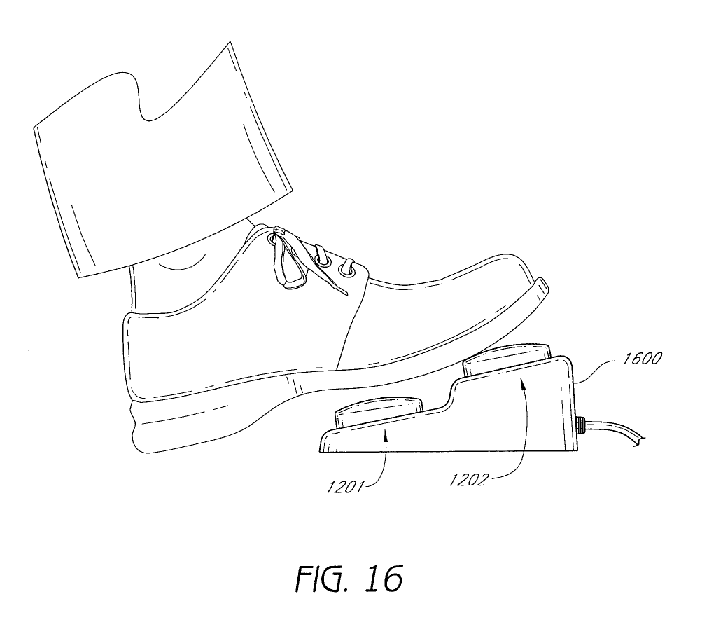

FIG. 16 shows an alternate embodiment of the multi-level controller 1600 wherein the levels 1201, 1202 and the various control devices are oriented in a sloped fashion to provide relatively better ergonomic access. One of ordinary skill in the art will recognize that the relatively horizontal arrangement shown in FIG. 13 and the sloped arrangement shown in FIG. 16 are not mutually exclusive, but can be combined (for example, in one embodiment, the lower levels, such as the level 1201 is oriented relatively more towards the horizontal with less slope, and the upper levels, such as the level 1202 are oriented with relatively more slope to better conform to the angle of the foot when operating the control devices). In one embodiment, the levels 1201 and 1202 are spaced to avoid accidental pressing of the controls on level 1201 when the user's toe operates controls on the level 1202. In one embodiment, one or more switches are provided to the sides, top or bottom of the multi-level controller 1200 or 1600, to allow users to select various functions or commands for the butt ons and/or to select the software operating systems such as, for example, Microsoft Windows Apple Mac operation system, etc. 1). In one embodiment, a switch is provided to allow the user to select which buttons are programmable and which buttons have fixed functions. For example, in one example embodiment, a switch is provided to allow all buttons to be programmable by software on the computer or to allow buttons A and B to be definable while buttons C, D and E mimic mouse right click, mouse left single click, and mouse left double click.

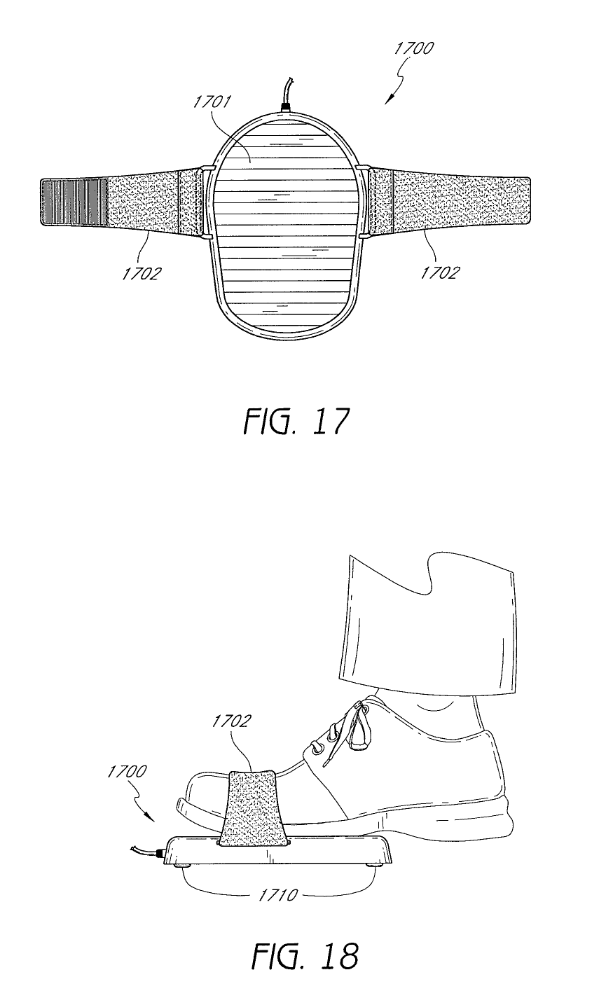

FIG. 17 shows a foot-operated mouse 1700 with attachment straps 1702. A foot pad area 1701 is provided for the sole of the foot or shoe, and the straps 1702 are provided with a closure mechanism (e.g., Velcro, clasp, snap, etc.) to hold the foot or shoe as shown in FIG. 18. As with a conventional hand-operated mouse, the foot-operated mouse 1700 glides on pads or rollers 1710 as shown in FIG. 18. In one embodiment, the straps 1702 are elastic. In one embodiment, the straps 1702 are elastic and the closure mechanism is omitted. In one embodiment, the straps 1702 are elastic and adjustable in length. In one embodiment, the straps 1702 are elastic and adjustable in length, and the closure mechanism is omitted. In one embodiment, the rollers 1710 are installed under or on the sides of the foot-operated mouse 1700. The rollers 1710 help the foot-operated mouse 1700 turn and slide in directions more easily.

As with a conventional hand-operated mouse, the foot-operated mouse 1700 can be provided to a computer system by wired connection or wirelessly. Movement of the foot-operated mouse can be measured using conventional mouse-tracking techniques, such as, for example, roller balls, optical systems, sensing pads, sensing tablets, radio-frequency tracking, ultrasonic tracking, etc. The foot-operated mouse 1700 can be connected to a suitable port (e.g., USB port, firewire port, wireless port, etc.) on the multi-level foot-operated controller 1200 and/or the mouse 1700 can be connected to a suitable port located on the computer or other device.

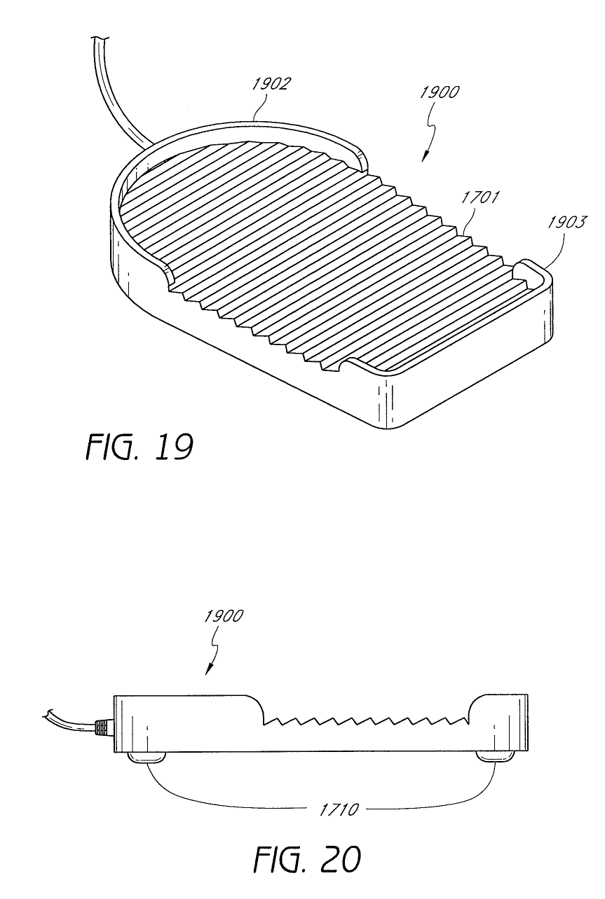

FIG. 19 shows an open-style foot-operated mouse 1900. The foot-operated mouse 1900 is similar to the foot-operated mouse 1700 and includes a traction surface 1701 for the sole of the foot or shoe. The surface 1701 can configured be ribbed, rubberized, dimpled, etc., to increase traction and reduce slip. In one embodiment, an optional toe border 1902 is provided to help prevent forward-slip of the shoe. In one embodiment, an optional heel border 1903 is provided to help prevent slip of the shoe. In one embodiment, the length of the foot operated mouse 1900 is adjustable to allow the foot-operated mouse 1900 to be sized to the user's foot or shoe. FIG. 20 shows a side view of the foot-operated mouse 1900. In one embodiment, the surface 1701 includes a magnetic piece (e.g., magnet or magnetic material) for connecting to another magnetic piece provided to the sole of the foot or shoe. In one embodiment, surface 1701 includes a Velcro piece for connecting the a Velcro piece provided to the sole of the foot or shoe.

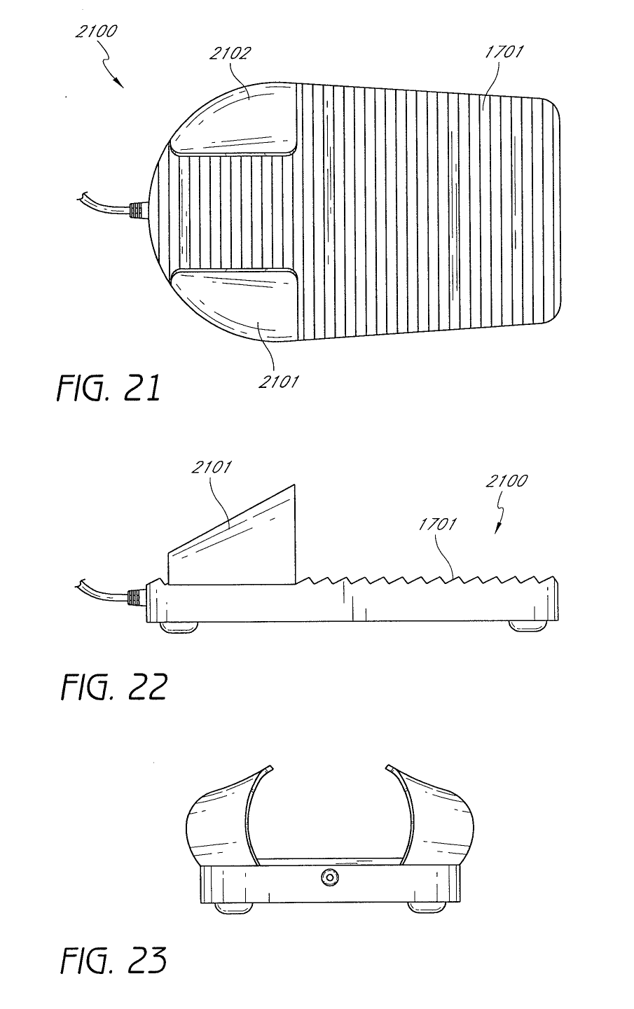

FIG. 21 is a top view of an open-style foot-operated mouse 2100 similar to the foot-operated mouse 1900. In the mouse 2100, the toe border 1902 has been extended to form one or more toe guards 2101, 2102 that fully or partially enclose the toe area of the shoe or foot. In one embodiment, the optional heel border 1903 is provided to the mouse 2100. In one embodiment, the length of the foot operated mouse 2100 is adjustable to allow the foot-operated mouse 2100 to be sized to the user's foot or shoe. FIGS. 22 and 23 show respective side and front views of the foot-operated mouse 2100.

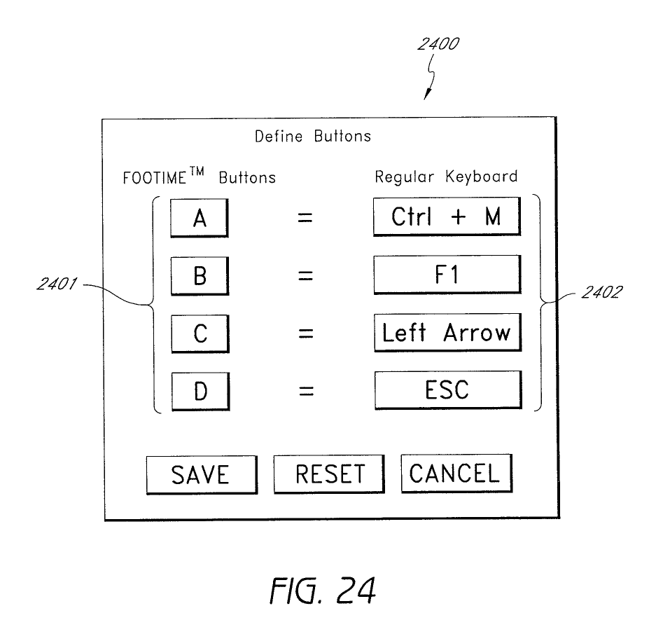

FIG. 24 shows an example of a graphical user interface corresponding to control software for assigning functions to buttons on a foot-operated controller, such as the foot-operated controllers described above. The user interface screen includes one or more fields 2401 corresponding to buttons or other controls on the foot-operated controller, and one or more fields 2402 indicating actions to perform when the corresponding user control is operated. Thus, for example, in a foot-operated controller with four buttons labeled A, B, C, D, the user can use the graphical interface to program the four buttons to correspond to keyboard functions, such as, for example, ctrl/M, F1, left cursor, esc, etc. In one embodiment, the user can use the graphical interface to program one or more of the buttons (or other control devices) to correspond to multiple keyboard functions, such as, for example, control/M followed by F2, etc. In one embodiment, the user can use the graphical interface to program one or more of the buttons (or other control devices) to correspond to one or more operating system messages (e.g., select menu item, etc.).

In one embodiment, the user can use the graphical interface to program one or more of the buttons (or other control devices) by selecting a corresponding computer program (e.g., Microsoft WORD, Adobe Photoshop, Microsoft Windows, Apple OS, Linux, etc.) that will be used in connection with the foot-operated controller. By knowing the program to be used, the control software can program the foot-controlled device to operate commonly-used functions associated with the program. The control software can also provide the user with a list of functions or actions associated with the program (e.g., save, copy, etc.) and allow the user to select desired program functions corresponding to desired control devices on the foot-operated control device. In one embodiment, the control software performs functions based on the program running in the active window on the user's computer screen such that when the user changes to an active window running a different program, the operation of the foot-operated control is changed accordingly.

For purposes of summarization, certain aspects, advantages and novel features are described herein. Of course, it is to be understood that not necessarily all such aspects, advantages or features need to be present in any particular embodiment. In addition, although certain aspects and design features are described with respect to certain embodiments, it is to be understood that aspects and design features described can be incorporated into other embodiments.

It will be evident to those skilled in the art that the invention is not limited to the details of the foregoing illustrated embodiments and that the invention can be embodied in other specific forms without departing from the spirit or essential attributes thereof; furthermore, various omissions, substitutions, and changes can be made without departing from the spirit of the invention. For example, various types of control mechanisms may be used with any of the embodiments. The various embodiments may be wired or wireless. Different aspects of the various embodiments are interchangeable. The foregoing description of the embodiments is, therefore, to be considered in all respects as illustrative and not restrictive, with the scope of the invention being delineated by the appended claims and their equivalents.

What is claimed is:

1. A foot-operated mouse, comprising:
a housing, said housing comprising a lower surface configured to slide on a desired surface, said housing comprising an upper surface for contacting a sole of a foot or a sole of a shoe;
at least a portion of a motion-sensing apparatus, said motion-sensing apparatus configured to measure motion of said housing; and
a controller configured to convert motion data from said motion-sensing apparatus into mouse-movement data for a computer.

2. The foot-operated mouse of claim 1, said housing further comprising a toe border.

3. The foot-operated mouse of claim 1, said housing further comprising a heel border.

4. The foot-operated mouse of claim 1, wherein a length of said housing is adjustable.

5. The foot-operated mouse of claim 1, said housing further comprising one or more straps.

6. The foot-operated mouse of claim 1, said housing further comprising one or more elastic straps.

7. The foot-operated mouse of claim 1, said housing further comprising a toe guard.

8. The foot-operated mouse of claim 1, wherein said upper surface is configured as a traction surface.

9. The foot-operated mouse of claim 1, further comprising one or more rollers provided to said lower surface.

10. The foot-operated mouse of claim 1, further comprising one or more pads provided to said lower surface.

11. The foot-operated mouse of claim 1, said housing further comprising a closed toe guard.

12. The foot-operated mouse of claim 1, said housing further comprising magnetic piece provided to said upper surface.

13. The foot-operated mouse of claim 1, said housing further comprising a Velcro piece provided to said upper surface.
